(19) United States
(12) Patent Application Publication
(10) Pub. No.: US 2023/0151972 A1
(43) Pub. Date: May 18, 2023

(54) Oven with specific catalyst, method

(71) Applicant: BSH Hausgeräte GmbH, Munich (DE)

(72) Inventors: Frank Jördens, Traunstein (DE); Klemens Roch, Trostberg (DE); Marco Pietsch, Palling (DE); Evelin Schmid, Trostberg (DE); Harald Pfersch, Freilassing (DE); Olaf Helmer, Sankt Augustin (DE)

(21) Appl. No.: 17/987,902

(22) Filed: Nov. 16, 2022

(30) Foreign Application Priority Data
Nov. 17, 2021 (DE) 102021212941.2

(51) Int. Cl. F24C 15/20; B01J 23/889; B01J 35/04; B01D 53/86

(52) U.S. Cl. CPC F24C 15/205; B01J 23/8892; B01J 35/04; B01D 53/8668; F24C 14/02

(57) ABSTRACT

An oven includes a cooking compartment for preparing food, a vapor extraction apparatus designed to extract vapors from the cooking compartment, and a catalyst fluidically coupled to the vapor extraction apparatus and designed to convert catalytically the vapors extracted in the vapor extraction apparatus. The catalyst includes a carrier and a layer of catalyst material applied on the carrier. In a normal mode of the oven for preparing food to be cooked, the catalyst has a concentration of acetic acid in the converted vapors which concentration of acetic acid amounts to less than or equal to 5 ppm. The oven is also able to operate in a pyrolysis mode which differs from the normal mode.

### CROSS-REFERENCES TO RELATED APPLICATIONS

This application claims the priority of German Patent Application, Serial No. 202021212941.2, filed Jan. 8, 2018, pursuant to 35 U.S.C. 119(a)-(d), the disclosure of which is incorporated herein by reference in its entirety as if fully set forth herein.

### BACKGROUND OF THE INVENTION

The invention relates to an oven and to a method of operating an oven.

It would be desirable and advantageous to provide an improved oven and improved method for operating an oven to obviate prior art shortcomings.

### BRIEF SUMMARY OF THE INVENTION

According to one aspect of the invention, and oven includes a cooking compartment for preparing food, a vapor extraction apparatus designed to extract vapors from the cooking compartment, and a catalyst fluidically coupled to the vapor extraction apparatus and designed to convert catalytically the vapors extracted in the vapor extraction apparatus, said catalyst including a carrier and a layer of catalyst material applied on the carrier, wherein the oven operates in a normal mode in which food to be cooked is prepared and a pyrolysis mode which differs from the normal mode, with the catalyst having in the normal mode of the oven a concentration of acetic acid in the converted vapors which concentration amounts to less than or equal to 5 ppm.

As a result, generation of unwanted odor components is optimized during the catalytic conversion of vapors and a particularly advantageous avoidance of unpleasant odor components can be achieved. In particular acetic acid is as a result not present in the converted vapors in the normal mode, or is present only to such an extent that it is in particular imperceptible. As a result, it is also possible to prevent any odor corruption of the preparation aromas of the food to be cooked from occurring in the normal mode.

According to another advantageous feature of the invention, the catalyst can be embodied such that, in the normal mode of the oven, a concentration of acetic acid in the converted vapors amounts to between 1 ppm and 5 ppm.

According to another advantageous feature of the invention, the catalyst can be embodied such that, in the pyrolysis mode of the oven, a concentration of acetic acid in the converted vapors is less than 100 ppb. In this way, the occurrence of acetic acid can be practically fully avoided during the conversion of the vapors. An only partial conversion of ethanol into acetic acid is thus avoided.

According to another advantageous feature of the invention, the catalyst can have an activity rate of less than or equal to 35 percent at temperature values in the normal mode of the oven. In particular, the catalyst can have an activity rate of more than 70 percent at temperature values in the pyrolysis mode. This applies in particular to a comparison substance, in particular CO and/or C3H6. Here, the activity rate for a catalyst can also be determined in particular by considering the space velocity, the carrier substrate and the substance (comparison substance), the substance concentration of the base substances in a test reactor. In this example, the catalyst was subjected to a volume of 7.6 ml with a gas flow of 8 l/min and subsequent content substances (540 ppm CO, 565 ppm C3H6 and 50000 ppm O2, remainder N2).

This may also apply equivalently to at least one component of the vapors. In particular, it may apply to volatile compounds, e.g. ethanol. At least ethanol is practically not converted in the normal mode, and thus no or only a negligible vinegar odor is produced. This occurs in particular when ethanol is only partially oxidized; such an oxidization is therefore practically minimal with the activity rate in the normal mode. In the pyrolysis mode, on the other hand, an almost complete oxidization of the ethanol into carbon dioxide and water takes place, so that the occurrence of an unwanted vinegar odor can be avoided. An unwanted only partial conversion of the ethanol in the normal mode can therefore be avoided and an almost complete conversion in the pyrolysis mode can be achieved with the catalyst, so that a strong vinegar odor can be avoided in all operating modes of the oven.

An oven according to the invention now makes it possible in an improved manner to reduce unpleasant odors arising from malodors or foreign odors in the normal mode during the conversion of components in a vapor flow, in particular during the oxidization of a substance, in particular ethanol. There is no notable occurrence of unpleasant odors as a result of acetic acid formation. It is thereby likewise achieved that a reduction in the proportions of odor components and also other gaseous substances, which are transported into the environment in the vapor flow of the oven during the pyrolysis mode, is achieved. On account of the specific embodiment of the catalyst material in this regard, very differentiated activity rates are enabled in the different operating modes of the oven. Because this activity rate is relatively low precisely in the normal mode, only a relatively low catalytic conversion of components in the vapor flow also takes place here, significantly reducing the occurrence of unpleasant odors in the normal mode. Furthermore, it is however also achieved that precisely at significantly higher temperatures, such as occur in the pyrolysis mode, a relatively high activity rate results and thus a very advantageous catalytic conversion ensues. It is thus also achieved that the basic activity of the catalyst, in particular of the catalyst material of the catalyst, is adapted such that it is substantially only fully effective in the pyrolysis mode. This oven particularly advantageously enables the occurrence of malodors to be minimized. Here, it is achieved in particular that any vinegar odor occurring in the outlet flow of the oven is below a specific concentration. With an oven according to the invention, during catalysis the specific concentration of the vinegar odor and thus the concentration of acetic acid in this exhaust flow is less than or equal to 5 ppm, in particular in the range between 1 ppm and 5 ppm. A vinegar odor in this connection is one example of a malodor as specified above.

According to another advantageous feature of the invention, the catalyst can have an activity rate, mentioned above in this connection, which at temperature values in the normal mode is less than or equal to 30%, in particular less than or equal to 20%, and the activity rate at temperature values in the pyrolysis mode is greater than 80%. Individual activity rates of the catalyst are therefore made possible for specific states of the vapors with this oven. Here, the catalyst is configured such that the activity of the catalyst material is adapted so as to be substantially only fully effective in the pyrolysis mode. With an oven according to the invention, it is thus possible to convert components of the vapors catalytically in such a way that practically no activity of the catalyst takes place in the normal mode but that a very high level of activity takes place in the pyrolysis mode, so as to convert these components particularly extensively and effectively and avoid an unwanted generation of odor.

According to another advantageous feature of the invention, the activity rate can be an oxidation of a substance of the vapors, in particular ethanol.

In particular, the activity rate in the present context describes the percentage of the catalytic conversion of a gaseous compound at a certain temperature value.

According to another advantageous feature of the invention, the temperature values in the normal mode can be less than or equal to 330° C., in particular 300° C. In the pyrolysis mode, the temperature values can be greater than or equal to 375° C., in particular greater than or equal to 400° C., in particular greater than or equal to 485° C.

An oven according to the invention is particularly advantageous in that for the substance of the vapors, the activity rate at temperatures greater than or equal to 425° C. can be greater than or equal to 90 percent. Provision may be made for the activity rate of the catalyst at lower temperatures up to a temperature value of 275° C., in particular for the substance of the vapors, to amount to no more than 33 percent. According to another advantageous feature of the invention, the activity rate can amount to no more than 15 percent at temperature values up to 275° C.

According to another advantageous feature of the invention, the catalyst material of the catalyst can be free from precious metals. This means that the catalyst material is composed without precious metals. It is particularly advantageous that the catalyst material is free from platinum and/or palladium. These exemplary embodiments advantageously contribute to the activity of the catalyst or the activity rate of the catalyst being very low in the normal mode and very high in the pyrolysis mode. Unwanted odor generation is minimized by it being possible to effectively minimize the activity in the normal mode. On the other hand, there is a very high level of activity in the pyrolysis mode, so that a very advantageous catalytic conversion of the components or substances of the vapors ensues. Provision of a catalyst material that is free from precious metals particularly advantageously enables these particularly strongly different activity rates in the different temperature ranges, as given on the one hand in the normal mode and on the other hand in the pyrolysis mode.

According to another advantageous feature of the invention, the catalyst material of the catalyst can include a first metal oxide having a metal from the manganese group of the periodic table. The catalyst material of the catalyst can include a second metal oxide having a metal from the copper group of the periodic table, and the catalyst material can include a third metal oxide having a metal from the lanthanides of the periodic table. This is a very specific composition of the catalyst material. In particular, at least three different metal oxides can be used here. The catalyst material is thus a multi-metal-oxide composition having at least three different specific metal oxides. This, too, supports the above-cited specific embodiment with regard to the strongly different activity rates in the individual temperature ranges of the normal mode on the one hand and of the pyrolysis mode on the other hand.

According to another advantageous feature of the invention, a mass proportion of the first metal oxide relative to the total catalyst material can amount to between 1.0 and 2.0, in particular in comparison to at least one other component of the catalyst material, in particular to a second metal oxide of the catalyst material and/or to a third metal oxide of the catalyst material. In particular, manganese oxide thus forms part of the total catalyst material in this proportion.

According to another advantageous feature of the invention, a mass proportion of the second metal oxide relative to the total catalyst material can amount to between 0.5 and 1.5, in particular in comparison to at least one other component of the catalyst material, in particular to a first metal oxide of the catalyst material and/or to a third metal oxide of the catalyst material. In particular, copper oxide (Cu₂O) thus forms part of the total catalyst material in this proportion.

According to another advantageous feature of the invention, a mass proportion of the third metal oxide relative to the total catalyst material can amount to between 2.0 and 4.0, in particular in comparison to at least one other component of the catalyst material, in particular to a first metal oxide of the catalyst material and/or to a second metal oxide of the catalyst material. The third metal oxide is in particular a cerium oxide, in particular Ce₂O₃.

Such mass proportions of the individual metal oxides and the metal oxides specified in this regard are particularly conducive to the above-cited advantages. The catalyst material is in particular embodied in each case only from the at least two metal oxides. It can therefore be formed from, in particular made of, two or advantageously of the three metal oxides.

According to another advantageous feature of the invention, the catalyst can have a honeycomb structure as the carrier. As a result, on the one hand a compact design and on the other hand however a surface which is as large as possible is particularly advantageously provided.

This carrier of the catalyst advantageously can have a surface greater than 40,000 mm². In particular, this surface can amount to between 40,000 mm² and 100,000 mm². All intermediate values between these range limits, particularly in increments of one, are advantageously to be regarded as disclosed.

It is also particularly advantageous that the oven is embodied without individual catalyst heating. This allows the number of components to be reduced. In particular, the oven can have at least one heating element, which in its primary function fulfills a heating function of the oven itself. It can be provided that this heating element is used in one exemplary embodiment to heat the catalyst. A multifunctionality of such a heating element of the oven is thereby provided. The heating element can be a grill heating element or a top heating element or another ring element as the heating element.

According to another advantageous feature of the invention, the heating element of the oven and the catalyst in this regard can be arranged at a distance of between greater than or equal to 12 mm, in particular between 12 mm and 25 mm, in relation to one another. A positioning of the catalyst in the vapor extraction apparatus of the oven is thus provided such that the vapor flow, in particular the vapor volume flow, reaches the catalyst directly and the catalyst is arranged accordingly in the direct vicinity of the cooking compartment and an abovementioned heating element of the oven.

In particular, as already mentioned above, the catalyst can be embodied such that a catalytically active temperature range in which the catalyst is effective lies above the temperature values such as occur in a normal mode of the oven.

According to another advantageous feature of the invention, a geometry of the catalyst can be embodied such that its flow resistance is equivalent to the size of a hole with a diameter of between 24 mm and 28 mm, in particular 26 mm. In particular, this geometric specification can be achieved by the carrier having a honeycomb structure, in particular a geometric surface of greater than or equal to 40,000 mm².

A cost-reduced oven can also be provided by the catalyst material also being free from precious metals. This also offers environmental advantages. Because this catalyst dispenses with the need for separate catalyst heating, which is provided primarily to heat the catalyst, it is also possible to avoid the undesired effects of locally limited overheating on the preparation result of a food to be cooked in the cooking compartment. In addition, the ease of integration of the catalyst is compact and other undesired influences can also be avoided.

A further independent aspect of the invention relates to an oven with a cooking compartment for preparing food. The oven also has a vapor extraction apparatus, with which vapors can be extracted from the cooking compartment. The oven also has a catalyst. This catalyst is fluidically coupled to the vapor extraction apparatus. Here, too, this means that vapors are guided in the vapor extraction apparatus to the catalyst in order to be converted catalytically there. In this way, the vapors extracted in the vapor extraction apparatus are catalytically influenced by way of the catalyst. The catalyst has at least one carrier, on which at least one layer of catalyst material is applied. The catalyst material has a first metal oxide having a metal from the manganese group. The catalyst material has a second metal oxide having a metal from the copper group. The catalyst material also has a third metal oxide having a metal from the lanthanides.

Exemplary embodiments of the abovementioned first independent aspect of the invention relating to the oven are to be regarded as advantageous exemplary embodiments of this further independent aspect of the oven.

A yet further independent aspect of the invention relates to an oven having a cooking compartment for preparing food. The oven also has a vapor extraction apparatus, with which vapors can be extracted from the cooking compartment. The oven also has a catalyst. The catalyst is fluidically coupled to the vapor extraction apparatus so that the vapors guided in the vapor extraction apparatus are influenced catalytically by means of the catalyst. The catalyst has at least one carrier, on which at least one layer of catalyst material is applied. The oven has at least one normal mode for preparing food to be cooked. The oven also has a pyrolysis mode which differs from the normal mode. The catalyst material of the catalyst is free from precious metals.

Exemplary embodiments of the abovementioned independent aspects relating to the oven are to be regarded as advantageous exemplary embodiments of this yet further independent aspect of the oven.

According to a further aspect of the invention, a method includes operating an oven in a normal mode in which food to be cooked in a cooking compartment is prepared, extracting vapors from the cooking compartment; and converting by a catalyst the vapors in the normal mode of the oven such that a concentration of acetic acid in the converted vapors amounts to less than or equal to 5 ppm.

According to another advantgaeous feature of the present invention, the oven can be operated in a pyrolysis mode which differs from the normal mode, and the catalyst can be embodied in the pyrolysis mode such that a concentration of acetic acid in the converted vapors is less than 100 ppb. During conversion, therefore, the concentration of acetic acid in the converted vapors is kept at less than or equal to 5 ppm in the normal mode and/or the concentration of acetic acid in the converted vapors is kept at less than or equal to 100 ppb in the pyrolysis mode.

A further independent aspect of the invention relates to the use of a catalyst with an activity rate, in particular for a substance of the vapors, which is less than or equal to 35 percent at temperature values in the normal mode and the activity rate at temperature values in the pyrolysis mode is greater than 70 percent for the catalytic treatment of a vapor flow in an oven. Such a use of a specific catalyst of this type for the catalytic treatment of a vapor flow in an oven makes it possible in a particularly advantageous manner for virtually no or only a slight activity of the catalyst, which has practically no influence on the odor emission, to take place in the normal mode of the oven and thus while carrying out a preparation program for a food to be cooked, while however in the pyrolysis mode of the oven a very high activity rate occurs and thus a very high catalytic conversion takes place.

A further aspect of the invention relates to a use of such a catalyst for use in an oven.

The designations “above”, “below”, “in front”, “behind”, “horizontal”, “vertical”, “depth direction”, “width direction”, “height direction” indicate positions and orientations during proper use and positioning of the oven.

Further features of the invention may be derived from the claims, the figures and the description of the figures. The features and combinations of features mentioned in the description above and the features and combinations of features set out below in the description of the figures and/or shown in the figures alone are usable not only in the respective combination given, but also in other combinations or alone without departing from the scope of the invention. Embodiments of the invention which are not explicitly shown in the figures and described, but which arise and can be created through separate combinations of features from the embodiments described, are therefore also to be considered as included and disclosed. Embodiments and combinations of features can also be regarded as disclosed which therefore do not have all the features of an originally formulated independent claim.

### BRIEF DESCRIPTION OF THE DRAWINGS

Exemplary embodiments of the invention will now be described in greater detail making reference to schematic drawings, in which:

FIG. 1 shows a schematic representation of an exemplary embodiment of an oven according to the invention.

### DETAILED DESCRIPTION OF EXEMPLARY EMBODIMENTS OF THE PRESENT INVENTION

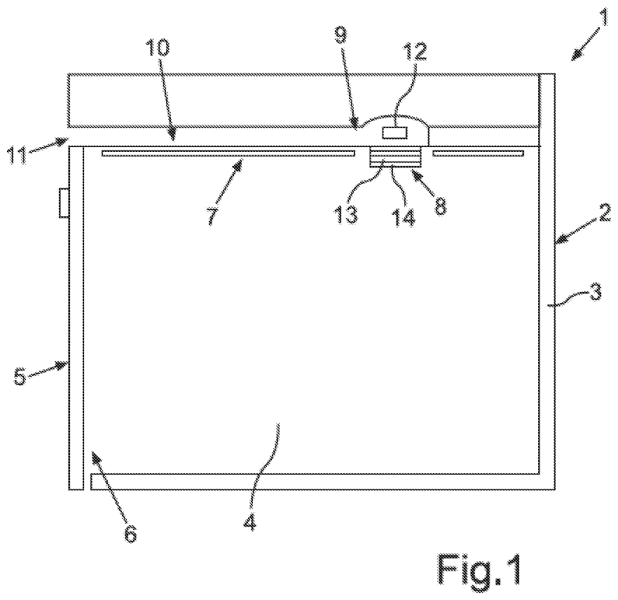

FIG. 1 shows an oven 1 in a schematic vertical sectional representation. The oven 1 has a housing 2. A muffle 3, which with its walls delimits a cooking compartment 4, is arranged in the housing 2. The oven 1 also has a door 5, which is arranged movably on the housing 2. The door 5 is provided to close a loading opening 6 of the muffle 3 on the front side. Furthermore, the oven 1 has at least one heating element 7. The heating element 7 is provided for the intended purpose in its primary function of generating heat during a preparation program of the cooking appliance 1. The heating element 7 can be for example a grill heating element or a top heating element or a bottom heating element or a ring heating element. In one exemplary embodiment, the oven 1 has a catalyst 8. The catalyst 8 is arranged at a distance from the heating element 7, wherein this distance amounts in particular to between 12 mm and 25 mm. In particular, in the present exemplary embodiment this distance is measured at the point at which the catalyst 8 is closest to the heating element 7. This distance can be measured for example in the horizontal direction.

The oven 1 also has a vapor extraction apparatus 9. Vapors arising in particular during the operation of the oven 1 in the cooking compartment 4 can be extracted by way of this vapor extraction apparatus 9 from the cooking compartment 4 and out of the oven 1 via an exhaust duct 10 of the vapor extraction apparatus 9. In particular, it is provided for example that an outlet opening 11 is formed on a front panel of the oven 1, via which these vapors, in particular the catalytically processed flows, can be expelled.

In one exemplary embodiment, the oven 1 also has a fan 12. By way of said fan, the vapors can be sucked out of the cooking compartment 4 and expelled via the exhaust duct 10. The catalyst 8 is arranged such that it is arranged in this generated vapor flow, and these vapors are thus catalytically converted by way of the catalyst 8.

In one exemplary embodiment, the catalyst 8 has at least one carrier 13. At least one coating 14 is applied on this at least one carrier 13. In one exemplary embodiment, this coating 14 has a catalyst material. The catalyst material of this coating 14 is advantageously free from precious metals. In particular, the catalyst material has a first metal oxide having a metal from the manganese group. This metal oxide is advantageously manganese oxide (MnO). A mass proportion of this first metal oxide advantageously amounts to between 1.0 and 2.0 relative to the total catalyst material. In one exemplary embodiment, the catalyst material has a second metal oxide which differs from the first metal oxide. This second metal oxide has a metal from the copper group. In particular, this second metal oxide is Cu₂O. The mass proportion of the second metal oxide advantageously amounts to between 0.5 and 1.5 relative to the total catalyst material. In one exemplary embodiment, the catalyst material advantageously has a third metal oxide which differs from the first two metal oxides. The third metal oxide has a lanthanide as the metal. This lanthanide is advantageously cerium. This third metal oxide is advantageously Ce₂O₃. A mass proportion of the third metal oxide advantageously amounts to between 2.0 percent and 4.0 percent relative to the total catalyst material. Advantageously, the catalyst material can be made only of these three metal oxides.

In one exemplary embodiment, the carrier 13 has a honeycomb structure. In particular, its surface is greater than 40,000 mm², in particular between 40,000 mm² and 100,000 mm².

The oven 1 has a normal mode. In the normal mode, in accordance with the intended purpose preparation programs for preparing food to be cooked are carried out in the receiving compartment 4. The normal mode advantageously extends over a temperature range from temperatures of less than 330° C. to this maximum value of 330° C. The oven 1 also has a pyrolysis mode which is different from a normal mode. This pyrolysis mode is not provided for preparing food to be cooked in the cooking compartment 4. In the pyrolysis mode, temperatures of greater than or equal to 485° C. are set in particular in the cooking compartment 4.

In one exemplary embodiment, the catalyst 8 has an activity rate for a substance, in particular for an oxidation of the substance, in particular ethanol, which is less than or equal to 35 percent at temperature values in the normal mode. In one exemplary embodiment, the catalyst 8 has an activity rate at temperature values in the pyrolysis mode which is greater than 70 percent, in particular with regard to the oxidation of this substance.

In one exemplary embodiment, the catalyst 8 is embodied such that, in the normal mode of the oven 1, a concentration of acetic acid in the converted vapors amounts to less than or equal to 5 ppm, in particular between 1 ppm and 5 ppm. In one exemplary embodiment, the catalyst 8 is embodied such that, in the pyrolysis mode of the oven 1, a concentration of acetic acid in the converted vapors is less than 100 ppb.

What is claimed is:

1. An oven, comprising:
a cooking compartment for preparing food;
a vapor extraction apparatus designed to extract vapors from the cooking compartment; and
a catalyst fluidically coupled to the vapor extraction apparatus and embodied to convert catalytically the vapors extracted in the vapor extraction apparatus, said catalyst including a carrier and a layer of catalyst material applied on the carrier,
said oven designed to operate in a normal mode in which food to be cooked is prepared and the catalyst has a concentration of acetic acid in the converted vapors amounts to less than or equal to 5 ppm, and a pyrolysis mode which differs from the normal mode.

2. The oven of claim 1, wherein the catalyst is embodied such that a concentration of acetic acid in the converted vapors in the normal mode of the oven amounts to between 1 ppm and 5 ppm.

3. The oven of claim 1, wherein the catalyst is embodied such that, in the pyrolysis mode of the oven, a concentration of acetic acid in the converted vapors is less than 100 ppb.

4. The oven of claim 1, wherein the catalyst has an activity rate for a comparison substance, which activity rate at a temperature value in the normal mode of the oven is less than or equal to 35%, in particular less than or equal to 30%, in particular less than or equal to 20%, and at a temperature value in the pyrolysis mode of the oven is greater than 70%, in particular greater than 80%, in particular greater than 90%.

5. The oven of claim 4, wherein the comparison substance is CO or C3H6.

6. The oven of claim 4, wherein the temperature value in the normal mode is less than or equal to 330° C., in particular less than or equal to 300° C.

7. The oven of claim 1, wherein the temperature value in the pyrolysis mode is greater than or equal to 400° C., in particular greater than or equal to 485° C.

8. The oven of claim 1, wherein the catalyst material is free from precious metal, in particular the catalyst material is free from platinum and palladium.

9. The oven of claim 1, wherein the catalyst material has a first metal oxide having a metal from the manganese group, a second metal oxide having a metal from the copper group, and a third metal oxide having a metal from the lanthanides.

10. The oven of claim 9, wherein a proportion of the first metal oxide relative to the total catalyst material amounts to between 1.0 and 2.0, in particular in comparison to at least one other component of the catalyst material, in particular to a second metal oxide of the catalyst material and/or to a third metal oxide of the catalyst material.

11. The oven of claim 9, wherein a proportion of the second metal oxide relative to the total catalyst material amounts to between 0.5 and 1.5, in particular in comparison to at least one other component of the catalyst material, in particular to a first metal oxide of the catalyst material and/or to a third metal oxide of the catalyst material.

12. The oven of claim 9, wherein a proportion of the third metal oxide relative to the total catalyst material amounts to between 2.0 and 4.0, in particular in comparison to at least one other component of the catalyst material, in particular to a first metal oxide of the catalyst material and/or to a second metal oxide of the catalyst material.

13. The oven of claim 1, wherein the carrier of the catalyst has a honeycomb structure and/or the carrier has a surface greater than 40,000 mm², in particular a surface between 40,000 mm² and 100,000 mm².

14. The oven of claim 1, further comprising a heating element, said catalyst being arranged at a distance from the heating element.

15. The oven of claim 14, wherein the distance is between greater than or equal to 12 mm.

16. The oven of claim 14, wherein the distance is between 12 mm and 25 mm.

17. A method, comprising:
operating an oven in a normal mode in which food to be cooked in a cooking compartment is prepared;
extracting vapors from the cooking compartment; and
converting by a catalyst the vapors in the normal mode of the oven such that a concentration of acetic acid in the converted vapors amounts to less than or equal to 5 ppm.

18. The method of claim 17, further comprising:
operating the oven in a pyrolysis mode which differs from the normal mode; and
designing the catalyst in the pyrolysis mode such that a concentration of acetic acid in the converted vapors is less than 100 ppb.
